(19) United States
(12) Patent Application Publication
(10) Pub. No.: US 2017/0358393 A1
(43) Pub. Date: Dec. 14, 2017

(54) WIRELESS CHARGING MODULE AND MAGNETIC FIELD SHIELDING SHEET FOR WIRELESS CHARGER

(71) Applicant: AMOSENSE CO., LTD., Chungcheongnam-do (KR)

(72) Inventors: Kil Jae JANG, Seongnam-si, Gyeonggi-do (KR); Min Sik JANG, Incheon (KR); Dong Hoon LEE, Yongin-si, Gyeonggi-do (KR)

(73) Assignee: AMOSENSE CO., LTD., Chungcheongnam-do (KR)

(21) Appl. No.: 15/531,209

(22) PCT Filed: Nov. 26, 2015
(86) PCT No.: PCT/KR2015/012780

§ 371 Date: May 26, 2017

(30) Foreign Application Priority Data
Nov. 27, 2014 (KR) 10-2014-0167629

(51) Int. Cl. H01F 27/36; H01F 38/14; H02J 50/10; H01F 27/28; H02J 7/02

(52) U.S. Cl. CPC H01F 27/365; H01F 27/2885; H02J 7/025; H02J 50/10; H01F 38/14

(57) ABSTRACT

A wireless charging module is provided. A wireless charging module according to an exemplary embodiment of the present invention comprises at least one wireless charging coil unit fixed to one surface of a shielding sheet, wherein the shielding sheet comprises: a ferrite sheet for shielding a magnetic field generated by a wireless high frequency signal, the ferrite sheet being formed of a plate-shaped member having a certain area; and position maintaining members attached to the upper surface and the lower surface of the ferrite sheet, respectively, such that, even when the ferrite sheet is broken into pieces by an external impact, the positions of the pieces of the broken ferrite sheet are maintained.

### TECHNICAL FIELD

The present invention relates to a wireless charging module and a magnetic field shielding sheet for a wireless charger.

### BACKGROUND ART

A contact type charging method and a non-contact type charging method are methods of charging a secondary battery mounted in an electronic device such as a portable terminal, a video, camera, or the like. The contact type charging method is a method in which charging is performed by bringing an electrode of a power receiving device and an electrode of a power supplying device into direct contact with each other.

Such a contact type charging method is generally used in a wide range of applications because of its simple structure, but there is an inconvenience such as a connection of a connector or the like to charge a battery as a power source by using a wired charger.

In order to solve this problem, the non-contact type charging method, in which coils corresponding to each other are provided in both a power receiving device and a power supplying device to use electromagnetic induction, has been proposed.

A non-contact type charger has been miniaturized by fixing a charging coil unit to one surface of a shielding sheet made of a ferrite sheet.

However, the ferrite sheet constituting the shielding sheet has a high brittleness due to a characteristic of a material thereof so that the ferrite sheet is easily broken by an external force and cracks are easily generated therein.

Therefore, when the ferrite sheet which supports the coil is broken into a plurality of pieces and a gap between the pieces of the broken sheet is then widened, there is a problem in that initially designed characteristics in consideration of a magnetic permeability, a saturated magnetic flux density, or the like which affects charging efficiency cannot be maintained, and thus the charging efficiency is degraded.

As an alternative thereto, a method in which a ferrite sheet is disposed between a pair of sheet layers and a shielding sheet is then formed with fine flake pieces through a flaking process has been proposed.

Since such a flake-type shielding sheet has a form in which the fine flake pieces are supported by the sheet layers, flexibility thereof is secured, but there is a problem in that a manufacturing cost is increased due to a separate flaking process.

In addition, when flake pieces of about 3 mm or less which have been broken through the flaking process are bent or deformed by an external force applied to the shielding sheet, the flexibility thereof is secured, but a gap between the fine flake pieces is not constantly maintained and is widened.

As described above, when the gap between the fine flake pieces is different from that of an initial state, there is a problem in that charging efficiency is degraded since characteristics such as a magnetic permeability, a saturated magnetic flux density, or the like are changed and differ from initially designed values.

### DISCLOSURE

### Technical Problem

The present invention is directed to providing a wireless charging module in which, even when a ferrite sheet is broken into a plurality of pieces by an external force, positions of the pieces are constantly maintained so that characteristics of the ferrite sheet are hardly changed and initially designed good charging efficiency may be maintained, and a shielding sheet for a wireless charger.

### Technical Solution

One aspect of the present invention provides a wireless charging module including at least one wireless charging coil unit, and a magnetic field shielding sheet disposed on one surface of the coil unit and configured to shield a magnetic field generated by the coil unit and concentrate the magnetic field in a designated direction, wherein the magnetic field shielding sheet includes a ferrite sheet having a certain area, and a position maintaining member attached to at least one of an upper surface and a lower surface of the ferrite sheet so that, even when the ferrite sheet is broken into pieces by an external impact, positions of the pieces of the broken ferrite sheet are constantly maintained.

The position maintaining members may be respectively provided on the upper surface and the lower surface of the ferrite sheet and attached to each of the upper surface and the lower surface of the ferrite sheet through an adhesive layer.

The ferrite sheet may be made of a sintered ferrite.

The ferrite sheet may be made of a Mn—Zn ferrite or a Ni—Zn ferrite. Preferably, the ferrite sheet may be made of a sintered Ni—Zn ferrite.

The position maintaining member may be a film member having an adhesive layer on one surface thereof.

The ferrite sheet may include at least one incision inducing groove formed on at least one of an upper surface and a lower surface of the ferrite sheet to be recessed at a predetermined depth in a width direction or a longitudinal direction.

Another aspect of the present invention provides a shielding sheet for a wireless charger, which is a magnetic field shielding sheet disposed on one surface of a wireless charging coil unit, the shielding sheet including a ferrite sheet made of a plate-shaped member having a certain area and configured to shield a magnetic field generated by the coil unit and concentrate the magnetic field in a designated direction, and a position maintaining member attached to at least one of an upper surface and a lower surface of the ferrite sheet so that, even when the ferrite sheet is broken into pieces by an external impact, positions of the pieces of the broken ferrite sheet are constantly maintained.

### Advantageous Effects

According to the present invention, even when a ferrite sheet is broken into a plurality of pieces by an external force, positions of the pieces are constantly maintained so that characteristics of the ferrite sheet are hardly changed and initially designed good charging efficiency can be maintained.

### DESCRIPTION OF DRAWINGS

FIGS. 1A and 1B are schematic diagrams illustrating wireless charging modules according to embodiments of the present invention, wherein FIG. 1A is a diagram illustrating a case in which one coil unit is provided and FIG. 1B is a diagram illustrating a case in which a plurality of coil units are provided.

FIGS. 2A to 2C are diagrams illustrating magnetic field shielding sheets applied to wireless charging modules according to embodiments of the present invention, wherein FIG. 2A is a diagram illustrating a case in which position maintaining members are provided on both surfaces of the ferrite sheet, FIG. 2B is a diagram illustrating a case in which a position maintaining member is provided on one surface of the ferrite sheet, and FIG. 2C is a diagram illustrating a case in which an incision inducing groove is provided in a ferrite sheet.

### MODES OF THE INVENTION

Hereinafter, embodiments of the present invention will be described in detail with reference to the accompanying drawings that they can be easily performed by those skilled in the art. Embodiments of the present invention may be embodied in several different forms, and are not limited to the embodiments described herein. In addition, parts irrelevant to the description will be omitted in the drawings in order to clearly explain the embodiments of the present invention. The same or similar components are denoted by the same reference numerals throughout this specification.

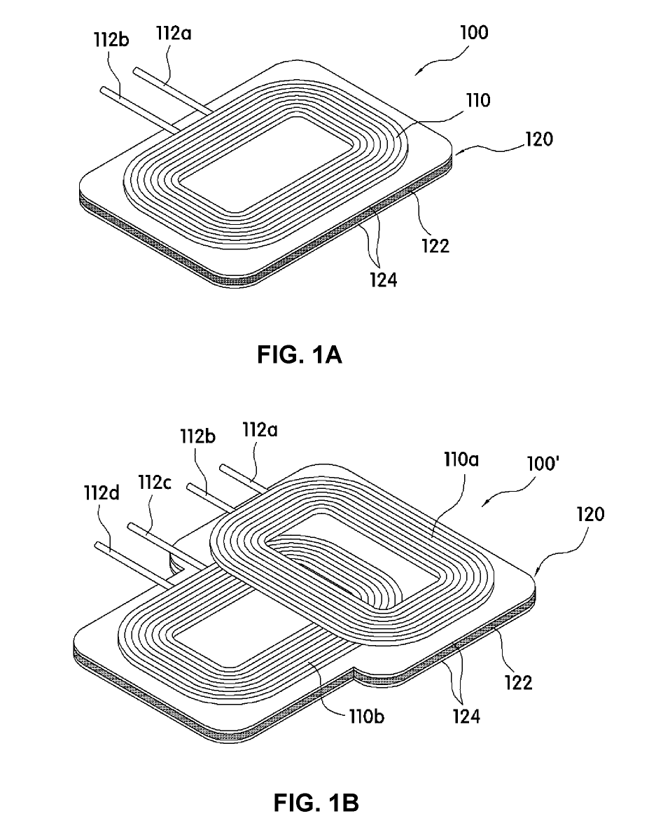

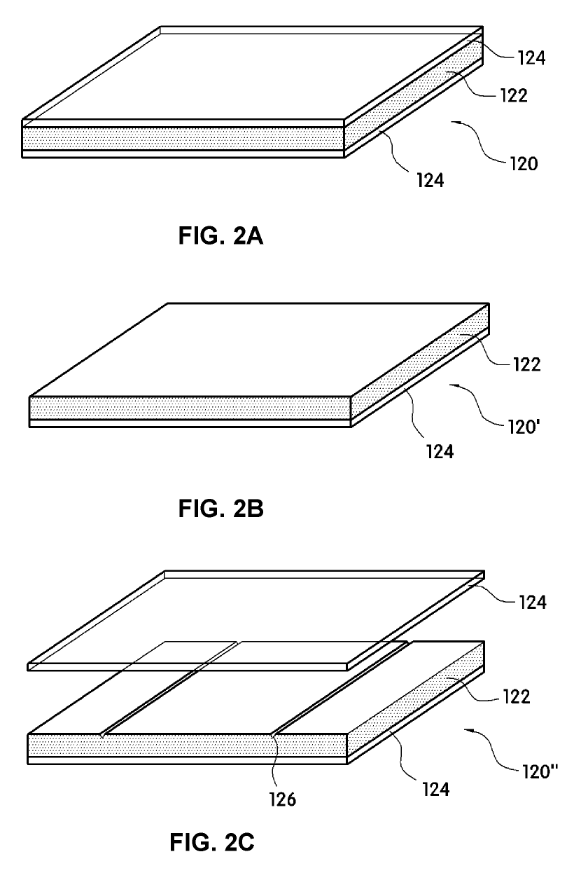

Referring to FIGS. 1A to 2C, a wireless charging module 100 or 100′ according to one embodiment of the present invention includes wireless charging coil units 110 or 110a and 110b and a magnetic field shielding sheet 120, 120′, or 120″.

The coil units 110, 110a and 110b transmit or receive wireless high frequency signals to and from portable electronic devices such as cellular phones, personal digital assistants (PDAs), portable media players (PMPs), tablet PCs, multimedia devices, and the like to transmit electric power thereto.

The coil unit 110 or 110a or 110b may be provided only one on one surface of the magnetic field shielding sheet 120, 120′, or 120″ as illustrated in FIG. 1A, and the plurality of coil units 110, 110a and 110b may be provided on one surface of the magnetic field shielding sheet 120, 120′, or 120″ as illustrated in FIG. 1B. The coil units 110 or 110a and 110b are fixed to the surface of the magnetic field shielding sheet 120, 120′, or 120″ through an adhesive layer.

Here, the adhesive layer may be an adhesive bond, polyvinyl chloride (PVC), rubber, a double-sided tape, or the like, and may include a conductive component. Meanwhile, although not illustrated, the adhesive layer may have a separate member such as polyamide (PI), polyethylene terephthalate (PET), or the like, and the separate member may be attached to the shielding sheet.

The coil units 110, 110a, and 110b may be formed with circular, elliptical, or rectangular coils wound in a clockwise or counterclockwise direction, but the present invention is not limited thereto, and the coil units 110, 110a, and 110b may be formed by etching a metal foil such as a copper foil or the like. Connection terminals 112a and 112b or 112a, 112b, 112c and 112d for electrically connecting to circuit boards protrude from both ends of the coil units 110 or 110a and 110b.

The coil units 110, 110a, and 110b may transmit electric power using an inductive coupling method based on an electromagnetic induction phenomenon through transmitted or received wireless power signals, and may serve as receiving (Rx) coils or as transmission (Tx) coils.

In addition, the coil units 110, 110a, and 110b may be replaced by an antenna pattern which performs a predetermined function by pattering a conductor such as a copper foil or the like on at least one surface of a circuit board made of a synthetic resin such as PI, PET, or the like in a loop-shape or by forming a loop-shaped metal pattern using a conductive ink.

Since a charging technique using such a magnetic inducing method is well known in the art, a detailed description thereof will be omitted.

The magnetic field shielding sheet 120, 120′, or 120″ is disposed on one surface of the coil units 110 or 110a and 110b and serves to shield magnetic fields generated by wireless high frequency signals generated by the coil units 110 or 110a and 110b and to concentrate the magnetic fields in a designated direction.

The magnetic field shielding sheet 120, 120′, or 120″ includes a ferrite sheet 122 and a position maintaining member 124.

The ferrite sheet 122 is made of a plate-shaped member having a certain area and is for shielding magnetic fields generated by wireless high frequency signals.

The ferrite sheet 122 may be made of a sintered ferrite, and may be made of a Mn—Zn ferrite or a Ni—Zn ferrite. Preferably, the ferrite sheet may be made of a sintered Ni—Zn ferrite.

In this case, the position maintaining member 124 for fixing positions of pieces of the ferrite sheet is disposed on at least one of an upper surface and a lower surface of the ferrite sheet 122 so that, even when the ferrite sheet 122 is divided into a plurality of pieces or cracks are generated by an external impact, positions of the pieces of the broken ferrite sheet are constantly maintained.

The position maintaining member 124 is attached to at least one surface of the ferrite sheet 122 through an adhesive layer. Accordingly, even when the ferrite sheet 122 having high brittleness is further divided or cracks are generated by an external impact, the divided pieces are not moved and the initial positions of the divided pieces are maintained and thus a gap between the divided pieces is not widened, and even when fine cracks are generated, the ferrite sheet 122 is prevented from being completely divided into a plurality of pieces by the cracks.

Accordingly, since the pieces are not moved and the positions thereof are fixed through the position maintaining member 124 attached through the adhesive layer even when the ferrite sheet 122 is divided or broken into pieces by an external impact, a gap is prevented from being generated between the pieces of the ferrite sheet. Therefore, cutting surfaces or fracture surfaces of a plurality of adjacent ferrite pieces may be maintained to always be in contact with each other, and thus a change of characteristics such as an initially designed magnetic permeability, saturated magnetic flux density (B), and the like may be minimized.

Therefore, unlike a conventional method in which efficiency is degraded when a ferrite sheet is divided or broken by an external impact, even when the ferrite sheet 122 is divided or broken into a plurality of pieces by an external impact, positions of the broken fine pieces are constantly maintained by the position maintaining member 124, cutting surfaces or fracture surfaces of the fine pieces are maintained to always be in contact with each other, characteristics of the ferrite sheet are hardly changed, and thus initially designed good charging efficiency may be maintained.

The position maintaining member 124 may be attached to only one of the upper surface and the lower surface of the ferrite sheet 122 as illustrated in FIG. 2B, but the present invention is not limited thereto. The position maintaining members 124 may be respectively provided on the upper surface and the lower surface of the ferrite sheet 122 as illustrated in FIG. 2A, may respectively restrain upper sides and lower sides of adjacent pieces of the ferrite sheet 122 among the broken ferrite sheet 122, and thus it is preferable for a retention force thereof to be increased.

Here, the position maintaining member 124 may be made of a plate-shaped sheet or a film member which has an adhesive layer on one surface and is made of a general resin.

Preferably, the position maintaining member 124 may be made of film members such as a PET film, a polyimide film, a polyester film, a polyphenylene sulfide (PPS) film, a polypropylene (PP) film, and a fluoride resin-based film such as polyethylene terephthalate (PTFE).

Meanwhile, as illustrated in FIG. 2C, the ferrite sheet 122 may include at least one incision inducing groove 126 to induce a pattern of the divided or broken ferrite sheet 122 in case the ferrite sheet is broken or divided by an external impact.

The incision inducing groove 126 is formed on at least one of the upper surface and the lower surface of the ferrite sheet 122 made of a plate-shaped member and is recessed at a predetermined depth in a width direction or a longitudinal direction.

That is, a portion of the ferrite sheet 122 in which the incision inducing groove 126 is formed has a relatively smaller thickness than the other portions.

Accordingly, when the ferrite sheet 122 is divided or damaged by an external impact, the portion of the ferrite sheet 122 in which the incision inducing groove 126 is formed is damaged or divided first to absorb the external impact, and thus the ferrite sheet 122 may adjust a pattern of the breaking.

Therefore, the ferrite sheet may be initially designed in consideration of a change of characteristics due to a pattern of the ferrite sheet divided by an external impact, and thus the ferrite sheet may be manufactured so that a required minimum charging efficiency may be satisfied even when the characteristics of the ferrite sheet are changed during division of the ferrite sheet by an external impact.

In addition, when a weak external impact is applied to a ferrite sheet having high brittleness, in the ferrite sheet 122 according to the embodiments of the present invention, the ferrite sheet is partially deformed according to the incision inducing groove 126 to absorb the external impact, and thus additional damage and division may be prevented.

Also, even when the ferrite sheet 122 is divided into a plurality of pieces by a strong external impact, the portion of the ferrite sheet 122 in which the incision inducing groove 126 is formed is divided first and an amount of impact is offset, and thus the number of divided pieces is minimized. Therefore, characteristics thereof are prevented from being rapidly changed.

While the embodiments of the present invention have been described above in detail, it should be understood by those skilled in the art that the scope of the present invention is not limited thereto but includes various alterations, changes, modifications, and equivalents derived from the basic concept of the present invention defined in claims to be described.

1. A wireless charging module comprising:
at least one wireless charging coil unit; and
a magnetic field shielding sheet disposed on one surface of the coil unit and configured to shield a magnetic field generated by the coil unit and concentrate the magnetic field in a designated direction,
wherein the magnetic field shielding sheet includes:
a ferrite sheet having a certain area; and
a position maintaining member attached to at least one of an upper surface and a lower surface of the ferrite sheet so that, even when the ferrite sheet is broken into pieces by an external impact, positions of the pieces of the broken ferrite sheet are constantly maintained.

2. The wireless charging module of claim 1, wherein the position maintaining members are respectively provided on the upper surface and the lower surface of the ferrite sheet.

3. The wireless charging module of claim 1, wherein the ferrite sheet is made of a sintered ferrite.

4. The wireless charging module of claim 1, wherein the ferrite sheet is made of a Mn—Zn ferrite or a Ni—Zn ferrite.

5. The wireless charging module of claim 1, wherein the position maintaining member is a film member having an adhesive layer on one surface thereof.

6. The wireless charging module of claim 1, wherein the ferrite sheet includes at least one incision inducing groove formed on at least one of an upper surface and a lower surface of the ferrite sheet to be recessed at a predetermined depth in a width direction or a longitudinal direction.

7. A shielding sheet for a wireless charger, which is a magnetic field shielding sheet disposed on one surface of a wireless charging coil unit, the shielding sheet comprising:
a ferrite sheet made of a plate-shaped member having a certain area and configured to shield a magnetic field generated by the coil unit and concentrate the magnetic field in a designated direction; and
a position maintaining member attached to at least one of an upper surface and a lower surface of the ferrite sheet so that, even when the ferrite sheet is broken into pieces by an external impact, positions of the pieces of the broken ferrite sheet are constantly maintained.

8. The shielding sheet of claim 7, wherein the position maintaining members are made of film members having an adhesive layer on one surface thereof, and are respectively attached to the upper surface and the lower surface of the ferrite sheet through the adhesive layer.
